(19) United States
(12) Patent Application Publication
(10) Pub. No.: US 2022/0357596 A1
(43) Pub. Date: Nov. 10, 2022

(54) Universal Prescription Eyewear Insert

(71) Applicant: Paul Wolowiec, Depew, NY (US)

(72) Inventor: Paul Wolowiec, Depew, NY (US)

(21) Appl. No.: 17/735,600

(22) Filed: May 3, 2022

Related U.S. Application Data
(60) Provisional application No. 63/184,292, filed on May 5, 2021.

(51) Int. Cl. G02C 9/04; G02C 1/06; G02C 5/02

(52) U.S. Cl. CPC G02C 9/04; G02C 1/06; G02C 5/02

(57) ABSTRACT

A eyewear insert for use when wearing secondary or safety eyewear. The insert is comprised of two rims surrounding two prescription lenses, wherein the two rims may have a bridge connector, which may be connected to a bridge having a bridge bend and optionally two flexible pieces, and wherein the top of the bridge is connected to two frame support attachments that are capable of sitting on top of any secondary eyewear.

### CROSS-REFERENCE TO RELATED APPLICATIONS

This application claims priority to U.S. Provisional application having Ser. No. 63/184,292, filed on May 5, 2021, the entire disclosure of which is hereby incorporated herein by reference.

### FIELD OF INVENTION

This invention is directed to an eyewear insert that can be used with safety goggles and glasses. In particular, the eyewear insert is a universal prescription eyewear insert.

### BACKGROUND OF INVENTION

For individuals requiring corrective eyeglasses, it is difficult to wear the corrective eyeglasses while wearing any type of safety or secondary eyewear. Most individuals just do the best that they can and wear the safety eyewear over their corrective eyeglasses. This can be very uncomfortable and often interferes with the functioning of the corrective eyeglasses because the corrective eyeglasses shift from where they should be located for the best vision correction.

Thus, it would be beneficial to find a way to comfortably and accurately correct eyesight while an individual is wearing secondary or safety eyewear.

### SUMMARY OF THE INVENTION

Accordingly, it is the subject of this invention to provide an eyewear insert for use while wearing secondary or safety eyewear. It is also the subject of this invention to provide a universal prescription eyewear insert.

An eyewear insert is disclosed including: two rims connected by a flat or curved bridge and wherein the two circular rims each contain a prescription lens; two frame rest supports connected perpendicularly to the bridge at either side of the bridge. The bridge may include a bridge bend and is connected to the two rims by two bridge connectors that are located at either end of the bridge.

The two frame rest supports have five sides each and wherein a bottom side is horizontal, a top side is horizontal and shorter than the bottom side, a back side is at a right or an acute angle from the bottom side, a front upper side is at an obtuse angle sloping down from the top side, a front lower side is vertical and extends from the front upper side to the bottom side.

The two frame rest supports each further include a first removable portion wherein the first removable portion is created by a cutout portion located on the front lower side defined by two sides that are parallel to the bottom side and a side that is parallel to the back side. The two frame rest supports each further include a second removable portion wherein the second removable portion is created by a cutout portion located on the front upper side defined by two sides that are parallel to the bottom side and a side that is parallel to the back side.

The eyewear insert is made of heat-moldable plastic and is intended to be used in combination with secondary eyewear.

An eyewear insert is disclosed consisting of: two circular rims connected by a flat or curved bridge and wherein the two rims each contain a lens; two frame rest supports connected perpendicularly to the bridge at either side of the bridge.

The two frame rest supports have five sides each and wherein a bottom side is horizontal, a top side is horizontal and shorter than the bottom side, a back side is at a a right or an acute angle from the bottom side, a front upper side is at an obtuse angle sloping down from the top side, a front lower side is vertical and extends from the front upper side to the bottom side.

The eyewear insert is made of heat-moldable plastic.

### BRIEF DESCRIPTION OF THE DRAWINGS

FIG. 1 depicts a perspective view of the eyewear insert.

FIG. 2 depicts a perspective view of the eyewear insert in combination with secondary eyewear.

FIG. 3 is a perspective view of another embodiment of the eyewear insert.

FIG. 4 is a perspective view of another embodiment of the eyewear insert.

FIG. 5 is a rear view of an embodiment of the eyewear insert in combination with secondary eyewear.

FIG. 6A is a perspective view of a component of the eyewear insert.

FIG. 6B is a perspective view of a component of the eyewear insert.

### DETAILED DESCRIPTION OF THE INVENTION

List of Components:
Eyewear insert—10
Rim—20
Lens—22
Bridge connector—24
Frame rest support—30
Bottom side—30a
Back side—30b
Top side—30C
Front upper side—30d
Front lower side—30e
Frame rest support extension—31
Extension bottom side—31a
Extension vertical side—31b
First removable portion—32
First lower horizontal side—32a
First vertical side—32b
First upper horizontal side—32c
Second removable portion—34
Second lower horizontal side—34a
Second vertical side—34b
Second upper horizontal side—34c
Bridge—40
Bridge adapters—42
Bridge bend—44
Secondary eyewear—50
Stopper—60

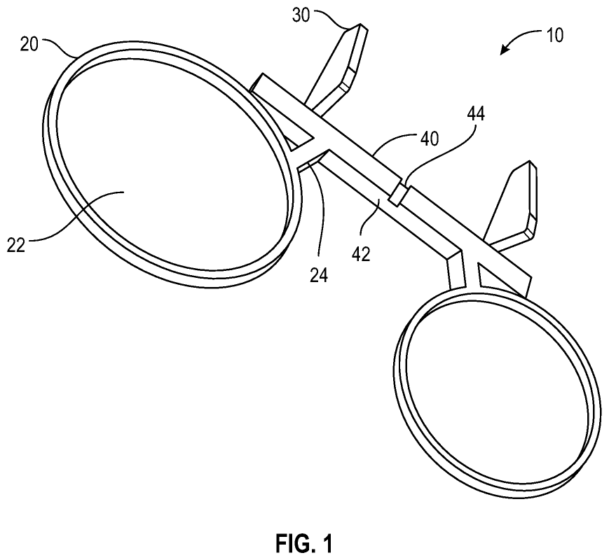

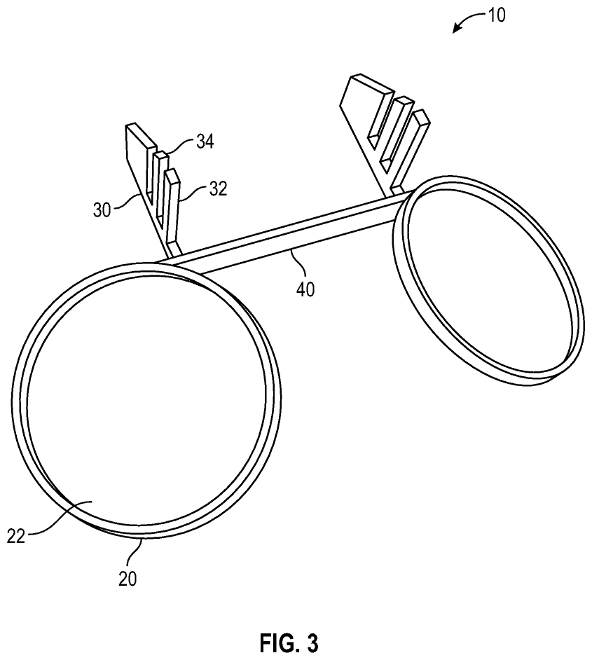

In one embodiment, as shown in FIG. 1, an eyewear insert 10 for use when wearing safety or secondary eyewear 50 is disclosed. The eyewear insert 10 is comprised of two rims 20 surrounding two lenses 22, preferably prescription, wherein the two rims 20 each have a bridge connector 24, which is connected to a bridge 40 having two flexible bridge adapters 42 on either side of a bridge bend 44 and wherein the top of bridge 40 is connected to two frame rest supports 30 at either end of bridge 40. Frame rest supports 30 are capable of sitting on top of any secondary eyewear 50. In a preferred embodiment, the rims 20 and lenses 22 are circular. In one embodiment, the bridge connectors 24 are any suitable pieces that will connect bridge 40 to rims 20. In another embodiment, the two flexible bridge adapters 24 are excluded and bridge 40 is embodied as a single piece (see FIGS. 3-5).

The eyewear insert 10 specifically excludes a frame and may be used behind the majority of loupes, safety frames, or any other secondary eyewear 50. In some embodiments, the lenses 22 of eyewear insert 10 may be tinted to offer protection from the sun. In another embodiment, two eyewear inserts 10 may be incorporated wherein a first eyewear insert 10 has prescription lenses 22 and wherein a second eyewear insert 10 has tinted lenses 22 for protection from the sun or for use while driving. Additionally, the eyewear insert 10 may have lenses 22 that are prescription lenses, reader lenses, sunglasses lenses, blue light blocker lenses, or yellow lenses for night vision.

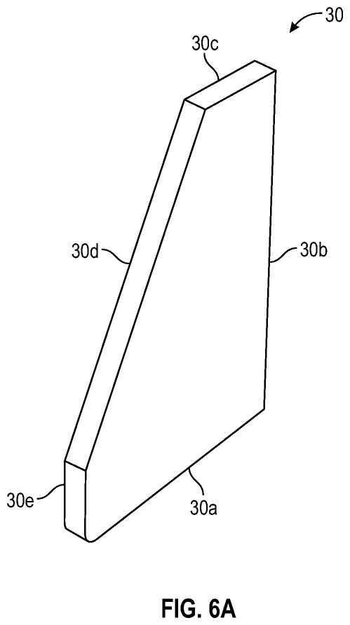

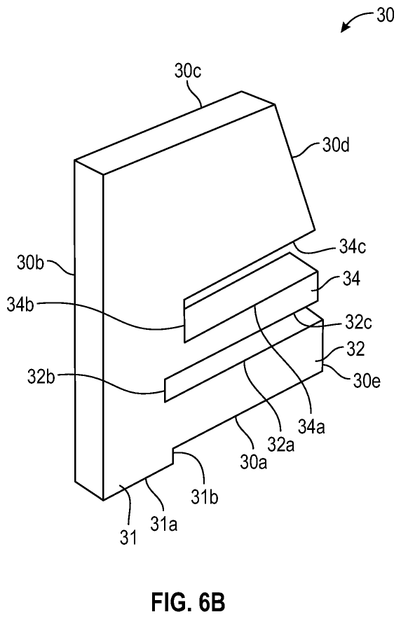

In one embodiment, see FIG. 6A, frame rest supports 30 are embodied as tabs that rest on top of the loupes or safety eyewear or other secondary eyewear 50. Preferably, the tab has five sides, wherein the bottom side 30a and the top side 30c are horizontal and bottom side 30a is longer than top side 30c. Back side 30b is vertical with respect to bottom side 30a. Front upper side 30d extends from top side 30c at an obtuse angle, preferably, 135°. Front lower side 30e extends from front upper side 30d, Front lower side 30e is vertical and connects to bottom side 30a. The shape may be a pentagon right or a pentagon left. The shape is largely a rectangle with the side facing the user having been cut away at the top. It is noted that any suitable structure or shape may be used for frame rest supports 30.

In an alternative embodiment, back side 30b is not vertical and is at an acute angle, for example 85°, with bottom side 30a. In another embodiment, front upper side 30d and front lower side 30e combine to create a front side (not numbered) and front upper side 30d is ⅔ of the front side and front lower side 30e is ⅓ of the front side.

The eyewear insert 10 of the present disclosure provides the ability to work with most frames. The frame rest supports 30 or tabs can be of a variety of sizes to accommodate different sized secondary eyewear 50. Smaller frame rest supports 30 may be used for discrete use of the eyewear insert 10. Alternatively, larger frame rest supports 30 may be used for easier use of the eyewear insert 10.

In another embodiment, bridge 40 of eyewear insert 10 has a bridge bend 44 which may be embodied as a small divot. In this embodiment, the eyewear insert 10 may be manually bent or heat molded at the bridge bend 44 thereby providing a snug fit to the loupes, safety eyewear, or other secondary eyewear 50. In a preferred embodiment, the entire eyewear insert 10 is heated to mold and conform to fit the curvature of the loupes, safety eyewear, sunglasses, or other secondary eyewear 50.

In another embodiment, the eyewear insert 10 is made of acrylic or nylon or any other suitable material. In another embodiment, the eyewear insert 10 may be translucent or any other color. In yet another embodiment, the eyewear insert 10 is fabricated by a 3D printer or any other suitable method of fabrication. In a preferred embodiment, the eyewear insert 10 is made of heat-moldable plastic or any other suitable material.

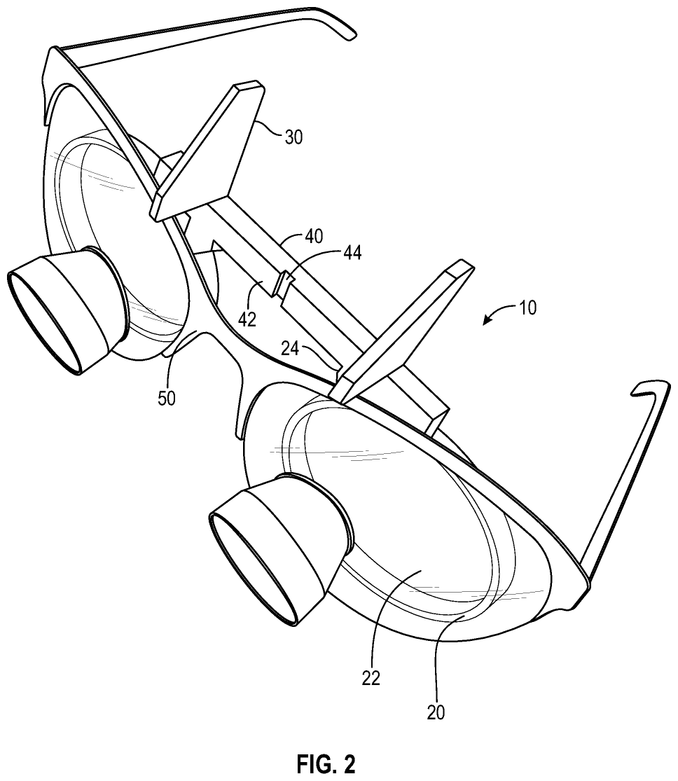

FIG. 2 depicts the eyewear insert 10 in connection with secondary eyewear 50. In this case, secondary eyewear 50 are depicted as loupes. As can be seen, frame rest supports 30 sit on top of the frame of the secondary eyewear 50. As described above, bridge 40 may be shaped to conform to the particular set of secondary eyewear 50 for a snug fit.

FIG. 3 depicts the eyewear insert 10 having a simpler bridge 40. In this embodiment, bridge 40 does not include bridge adapters 42 or a bridge bend 44. Also excluded are bridge connectors 24. In this embodiment, lenses 22 may be be curved or straight with respect to bridge 40. That is, the lenses 22 may sit straight or flush with bridge 40 or may be at a slight angle or curved from bridge 40. As above, this embodiment of the eyewear insert 10 may be manually bent or heat molded to provide a snug fit to the loupes, safety eyewear, or other secondary eyewear 50.

Another difference in FIG. 3 is that frame rest support 30 may be adjusted if the eyewear insert needs to drop down further on the eyewear. In this embodiment, frame rest support 30 has removable portions that can be cut or broken off to adjust the height of the eyewear insert 10. In this embodiment, frame rest support 30 has two portions that allow a user (not shown) to adjust the height.

FIGS. 3 and 6B depict frame rest support 30 having first removable portions 32 and second removable portion 34. If the eyewear insert 10 is too high, then first removable portion 32 can be removed so that the eyewear insert 10 sits lower on the secondary eyewear 50. If it is still too high, then second removable portion 34 may be removed. It is understood that while frame rest support 30 has been described with two removable portions, any suitable number of removable portions is envisioned. First removable portion 32 and second removable portion 34 are created by recesses in frame rest support 30.

Frame rest support 30 has a bottom side 30a that is horizontal, a back side 30b that is vertical, a top side 30c that is horizontal and shorter than bottom side 30a, a front upper side 30d that is at an obtuse angle, preferably 135°, with top side 30c, and a front lower side 30e is vertical. Also shown in FIG. 6B is frame rest support extension 31 that can provide a point of attachment to bridge 40.

Frame rest support extension 31 is approximately 2-4 mm and includes extension bottom side 31a and extension vertical side 31b. In this embodiment, at the bottom of back side 30b, extension bottom side 31a extends at a right angle or at an acute angle (preferably 85°), horizontally from back side 30b towards front lower side 30e and is at a right angle with extension vertical side 31b, which is at a right angle with bottom side 30a. Although depicted with the frame rest support 30 embodiment with first removable portion 32 and second removable portion 34, it is understood that frame rest support extension 31 may be included on the frame rest support 30 embodiment that does not have first removable portion 32 and second removable portion 34.

First removable portion 32 is created by recesses in frame rest support 30 defined by a cutout portion in the front lower side 30e. Three additional sides define the recess. At approximately 3 millimeters up from the front lower side 30e, a first lower horizontal side 32a travels towards the back side 30b and ends at a first vertical side 32b approximately 6 mm away from the back side 30b and this side travels up towards a first upper horizontal side 32c that travels towards the front upper side 30d (as in FIG. 6B) or towards the top of front lower side 30e (as in FIG. 3). In this way, a recess is defined that has a height of approximately 3 mm. Below the recess, first removable side 32 is created.

Second removable portion 34 is also created by recesses in frame rest support 30 defined by a cutout portion in the front upper side 30d. Three additional sides define the recess. At the bottom of front upper side 30d, a second lower horizontal side 34a travels towards back side 30b and ends at second vertical side 34b approximately 6 mm away from back side 30b and this side travels up towards second upper horizontal side 34c that travels towards the front upper side 30d. In this way, a recess is defined that has a height of approximately 3 mm. Below the recess, second removable side 34 is created.

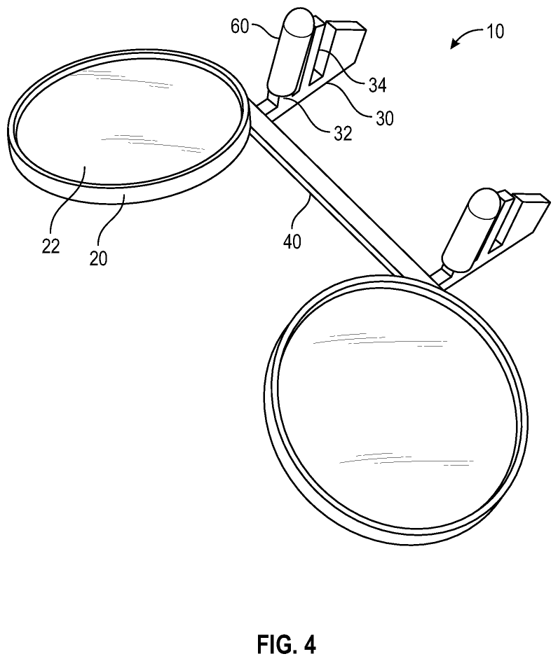

As seen in FIG. 4, the removable portions can also be used in combination with a stopper 60. Stopper 60 is not required, but may be helpful in preventing frame rest support 30 from moving while it is sitting on the secondary eyewear 60. In this embodiment, stopper 60 is inserted over first removable portion 32. In other embodiments, stopper 60 may be inserted over second removable portion 34. The stopper 60 may be rubber or soft plastic or any other suitable material.

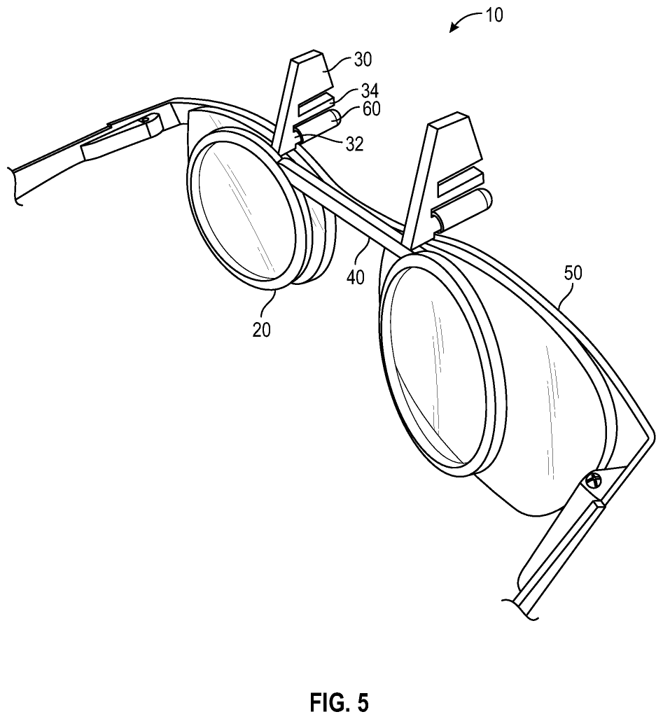

FIG. 5 depicts the eyewear insert 10 embodiment of FIG. 3 in combination with secondary eyewear 50.

The eyewear insert 10 of the present disclosure allows people that require corrective prescription glasses to use loupes, safety eyewear, or other secondary eyewear 50 without their regular glasses, but while having their vision corrected. The eyewear insert 10 may be configured with any prescription lens and may be used with almost any secondary eyewear 50.

It will be appreciated by those skilled in the art that while the eyewear insert 10 has been described in detail herein, the invention is not necessarily so limited and other examples, embodiments, uses, modifications, and departures from the embodiments, examples, uses, and modifications may be made without departing from the process and all such embodiments are intended to be within the scope and spirit of the appended claims.

What is claimed is:

1. An eyewear insert comprising:
two rims connected by a bridge and wherein the two rims each contain a lens; and
two frame rest supports connected to the bridge at either side of the bridge.

2. The eyewear insert of claim 1 wherein the two rims are circular in shape.

3. The eyewear inset of claim 1 wherein the bridge is flat.

4. The eyewear insert of claim 1 wherein the bridge is curved.

5. The eyewear insert of claim 1 wherein the bridge includes a bridge bend and is connected to the two rims by two bridge connectors that are located at either end of the bridge.

6. The eyewear insert of claim 1 wherein the lenses are prescription lenses.

7. The eyewear insert of claim 1 wherein the two frame rest supports are connected perpendicularly to the bridge.

8. The eyewear insert of claim 7 wherein the two frame rest supports have five sides each and wherein a bottom side is horizontal, a top side is horizontal and shorter than the bottom side, a back side is at a right or an acute angle from the bottom side, a front upper side is at an obtuse angle sloping down from the top side, a front lower side is vertical and extends from the front upper side to the bottom side.

9. The eyewear insert of claim 8 wherein the two frame rest supports each further include at least one removable portion wherein the at least one removable portion is created by a cutout portion located on the front upper side defined by two sides that are parallel to the bottom side and a side that is parallel to the back side.

10. The eyewear insert of claim 8 wherein the two frame rest supports each further include at least one removable portion wherein the at least one removable portion is created by a cutout portion located on the front lower side defined by two sides that are parallel to the bottom side and a side that is parallel to the back side.

11. The eyewear insert of claim 9 wherein the two frame rest supports each further include a second removable portion wherein the second removable portion is created by a cutout portion located on the front lower side defined by two sides that are parallel to the bottom side and a side that is parallel to the back side.

12. The eyewear insert of claim 1 wherein the eyewear insert is made of heat-moldable plastic.

13. The eyewear insert of claim 1 used in combination with secondary eyewear.

14. An eyewear insert consisting of:
two rims connected by a bridge and wherein the two rims each contain a lens; and
two frame rest supports connected to the bridge at either side of the bridge.

15. The eyewear insert of claim 14 wherein the two frame rest supports are connected perpendicularly to the bridge.

16. The eyewear insert of claim 15 wherein the two frame rest supports have five sides each and wherein a bottom side is horizontal, a top side is horizontal and shorter than the bottom side, a back side is at a a right or an acute angle from the bottom side, a front upper side is at an obtuse angle sloping down from the top side, a front lower side is vertical and extends from the front upper side to the bottom side.

17. The eyewear insert of claim 14 wherein the eyewear insert is made of heat-moldable plastic.

18. A frame rest support for use in an eyewear insert comprising:
five sides each and wherein a bottom side is horizontal, a top side is horizontal and shorter than the bottom side, a back side is at a right or an acute angle from the bottom side, a front upper side is at an obtuse angle sloping down from the top side, a front lower side is vertical and extends from the front upper side to the bottom side; and
at least one removable portion wherein the at least one removable portion is created by a cutout portion located on the front upper side defined by two sides that are parallel to the bottom side and a side that is parallel to the back side.

19. The frame rest support of claim 18 further including second removable portion wherein the second removable portion is created by a cutout portion located on the front lower side defined by two sides that are parallel to the bottom side and a side that is parallel to the back side.

20. The frame rest support of claim 19 further including an frame rest support extension wherein an extension bottom side extends horizontally from the bottom of the back side and towards the front lower side and ends at a right angle with an extension vertical side and wherein the extension vertical side ends at a right angle with bottom side.
